(19) United States
(12) Patent Application Publication
(10) Pub. No.: US 2026/0214027 A1
(43) Pub. Date: Jul. 23, 2026

(54) APPARATUSES AND WIRELESS COMMUNICATION METHODS FOR GROUP OF SESSIONS

(71) Applicant: INNOPEAK TECHNOLOGY, INC., Palo Alto, CA (US)

(72) Inventor: Tricci SO, Palo Alto, CA (US)

(21) Appl. No.: 19/142,153

(22) PCT Filed: Feb. 6, 2024
(86) PCT No.: PCT/US2024/014573

§ 371 Date: Jun. 20, 2025

Related U.S. Application Data
(60) Provisional application No. 63/444,773, filed on Feb. 10, 2023.

(51) Int. Cl. H04L 41/5003; H04L 41/0894

(52) U.S. Cl. CPC H04L 41/5003; H04L 41/0894

(57) ABSTRACT

A wireless communication method for a group of sessions includes receiving, by a network exposure function (NEF), an application function (AF) session create request from an AF, wherein the AF session create request is associated with a group of AF sessions and one or more quality-of-service (QoS) parameters and partitioning, by the NEF, the AF session create request into one or more first requests, wherein the one or more first requests are associated with one or more user equipments (UEs).

### CROSS-REFERENCE TO RELATED APPLICATIONS

This application claims priority to U.S. Provisional Application No. 63/444,773, filed on Feb. 10, 2023, which is hereby incorporated in its entirety by this reference.

### TECHNICAL FIELD

The present disclosure relates to the field of communication systems, and more particularly, to apparatuses and wireless communication methods for a group of sessions such as support for quality-of-service (QoS) flow resource allocation and QoS monitoring for a group of application function (AF) sessions.

### BACKGROUND

There is currently standardization activity in 3rd generation partnership project (3GPP) work studying an application function (AF) session. However, in current technologies, AF can only request for resource allocation and QoS monitoring for individual AF session. Enhancement for a group of AF sessions and related parameters is still an open issue. Therefore, there is a need for apparatuses and communication methods for a group of sessions such as support for quality-of-service (QoS) flow resource allocation and QoS monitoring for a group of application function (AF) sessions.

### SUMMARY

An object of the present disclosure is to propose apparatuses and wireless communication methods for a group of sessions such as support for quality-of-service (QoS) flow resource allocation and QoS monitoring for a group of application function (AF) sessions, which can solve these issues in the prior art and other issues and/or reduce a signaling overhead between an AF and a network such as a 5G core network (5GC). reduce a signaling overhead between an AF and a network such as a 5G core network (5GC).

In a first aspect of the present disclosure, a wireless communication method for a group of sessions includes receiving, by a network exposure function (NEF), an application function (AF) session create request from an AF, wherein the AF session create request is associated with a group of AF sessions and one or more quality-of-service (QoS) parameters and partitioning, by the NEF, the AF session create request into one or more first requests, wherein the one or more first requests are associated with one or more user equipments (UEs).

In a second aspect of the present disclosure, a wireless communication method for a group of sessions includes transmitting, by an application function (AF), an AF session create request to a network exposure function (NEF), wherein the AF session create request is associated with a group of AF sessions and one or more quality-of-service (QoS) parameters and requesting the NEF to partition the AF session create request into one or more first requests, wherein the one or more first requests are associated with one or more user equipments (UEs).

In a third aspect of the present disclosure, a wireless communication device includes a receiver configured to receive an application function (AF) session create request from an AF, wherein the AF session create request is associated with a group of AF sessions and one or more quality-of-service (QoS) parameters and an executor configured to partition the AF session create request into one or more first requests, wherein the one or more first requests are associated with one or more user equipments (UEs).

In a fourth aspect of the present disclosure, a wireless communication device includes a transmitter configured to transmit an application function (AF) session create request to a network exposure function (NEF), wherein the AF session create request is associated with a group of AF sessions and one or more quality-of-service (QoS) parameters and an executor configured to request the NEF to partition the AF session create request into one or more first requests, wherein the one or more first requests are associated with one or more user equipments (UEs).

In a fifth aspect of the present disclosure, a network device includes a memory, a transceiver, and a processor coupled to the memory and the transceiver. The network device is configured to perform the above method.

In a sixth aspect of the present disclosure, a non-transitory machine-readable storage medium has stored thereon instructions that, when executed by a computer, cause the computer to perform the above method.

In a seventh aspect of the present disclosure, a chip includes a processor, configured to call and run a computer program stored in a memory, to cause a device in which the chip is installed to execute the above method.

In an eighth aspect of the present disclosure, a computer readable storage medium, in which a computer program is stored, causes a computer to execute the above method.

In a ninth aspect of the present disclosure, a computer program product includes a computer program, and the computer program causes a computer to execute the above method.

In a tenth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a function entity according to an embodiment of the present disclosure.

FIG. 2 is a flowchart illustrating a wireless communication method for a group of sessions by a function entity according to an embodiment of the present disclosure.

FIG. 3 is a block diagram of a function entity according to an embodiment of the present disclosure.

FIG. 4 is a flowchart illustrating a wireless communication method for a group of sessions by a function entity according to an embodiment of the present disclosure.

FIG. 5 is a block diagram of a communication device according to an embodiment of the present disclosure.

FIG. 6 is a block diagram of a communication device according to an embodiment of the present disclosure.

FIG. 7 is a block diagram of a network device according to an embodiment of the present disclosure.

FIG. 8 is a block diagram illustrating a wireless communication architecture configured to implement some embodiments presented herein.

FIG. 9 is a flowchart illustrating of a group of AF sessions with QoS for resource allocation and/or QoS monitoring support configured to implement some embodiments presented herein.

FIG. 10 is a block diagram of an example of a computing device according to an embodiment of the present disclosure.

FIG. 11 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

A new network exposure function (NEF) service is introduced by some embodiments of this disclosure to support a network resource allocation and various quality-of-service (QoS) monitoring operation for a group of application function (AF) sessions which have been set up for a group of user equipments (UEs) selected by the AF. Each AF session within the group of UEs, if authorized by a policy control function (PCF), is allocated with the same set of QoS resources as requested by the AF. If the QoS monitoring is also requested for the group, the group of QoS flows for the corresponding UEs within the group which participate in the same application is to be monitored as requested by the AF. One or more QoS parameters to be measured are specified by the AF to imply a type of QoS monitoring measurement (e.g., delay, jitter and/or data rate etc.).

This NEF service coordinates the AF requests for the group of AF sessions with the respective 5G core network (5GC) NFs' responses and notifications between the AF and the 5GC. More specifically, the NEF verifies an authenticity of the AF's request and partitions the AF's request for the group of AF sessions into individual N5 request and to identify a proper serving PCF of the UE for the AF session within the group to process a N5 request. The UE's serving PCF further authorizes the N5 request before proceeding to derive policy and charging control (PCC) rules for a target QoS flow as indicated in the AF's request. The UE's serving PCF performs the PCC rule binding with the target QoS flow requested by the AF and, through the support of the UE's serving SMF, the PCF updates a N4 policy corresponding to QoS resources and QoS monitoring configurations indicated to the UE's serving UPF.

When the QoS monitoring for data rate for the group of QoS flows is requested by the AF for the group of AF sessions, the AF may also request the monitoring of a group of QoS flows against a specified maximum aggregated throughput which is a group maximum bit rate (Group-MBR) threshold and is included in the AF request. If the group-MBR monitoring is requested, the group of the QoS monitoring for data rate reports can be sent to the AF only if an aggregated bit rate exceed the group-MBR threshold. Otherwise, the group of QoS monitoring for data rate report can be sent to the AF according to the reporting frequency.

The following Table 1 describes the mapping of 4 types of new NEF service requests and the N5 service request.

TABLE 1

| Nnef_GroupOfAFSessionWithQoS | |
|---|---|
| Request | N5 request |
| Create | Requesting to allocate a network resource for a group |
| | of QoS flows corresponding to a group of AF sessions |
| | associated with a group of selected UEs. In addition, |
| | the QoS monitoring for a group of QoS flows can be |
| | also initiated as well. |
| Update | Updating (a) the list of UEs and their respective QoS |
| | flows of the corresponding AF sessions in the group, |
| | (b) the QoS resource allocation and/or (c) the type of |
| | QoS monitoring for the group of QoS flows. |
| | More than one of the above operations can be requested |
| | at the same time. |
| Revoke | Deleting the establishment of the group or specific AF |
| | session within the group. |
| Notify | Notifying AF with the bulk QoS monitoring report for |
| | all the AF sessions within the group. |

The Group-MBR threshold is described as follows: The Group-MBR threshold provides an upper bound of an aggregate bit rate across all GBR QoS flows corresponding to a group of protocol data unit (PDU) sessions of the UEs who participate in a group of transmissions concurrently (e.g., federated learning (FL) operation) with active user planes. The anchor user plane function (UPF) of the group of transmissions (e.g., FL operation) measures the aggregated bit rate across the set of selected QoS Flows against the Group-MBR threshold provided by the associated anchor session management function (SMF) of the corresponding group of PDU sessions that support the group of transmissions. The Group-MBR is provided by the AF to initiate the Group-MBR monitoring for a set of QoS flows of a group of PDU sessions supporting a group of concurrent transmissions.

In the case of the group QoS monitoring, either Group-MBR monitoring or group reporting for individual QoS flow data rate and not both will be supported at the same time by the NEF. NOTE-1: If Group-MBR threshold is provided, the QoS parameter(s) to be measured indicates the bit rate is provided. NOTE-2: When the event report is for Group-MBR monitoring, the QoS flow data rate reporting for the group of UEs provided to the AF by the NEF only when the Group-MBR threshold is exceeded.

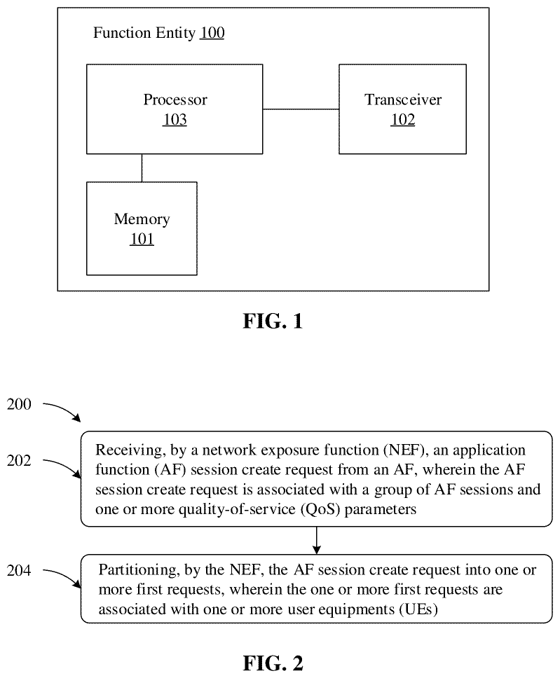

FIG. 1 illustrates an example of a function entity 100 according to an embodiment of the present disclosure. The function entity 100 is configured to implement some embodiments of the disclosure. Some embodiments of the disclosure may be implemented into the function entity 100 using any suitably configured hardware and/or software. The function entity 100 may include a memory 101, a transceiver 102, and a processor 103 coupled to the memory 101 and the transceiver 102. The processor 103 may be configured to implement proposed functions, procedures and/or methods described in this description. Layers of radio interface protocol may be implemented in the processor 103. The memory 101 is operatively coupled with the processor 103 and stores a variety of information to operate the processor 103. The transceiver 102 is operatively coupled with the processor 103, and the transceiver 102 transmits and/or receives a radio signal. The processor 103 may include application-specific integrated circuit (ASIC), other chipset, logic circuit and/or data processing device. The memory 101 may include read-only memory (ROM), random access memory (RAM), flash memory, memory card, storage medium and/or other storage device. The transceiver 102 may include baseband circuitry to process radio frequency signals. When the embodiments are implemented in software, the techniques described herein can be implemented with modules (e.g., procedures, functions, and so on) that perform the functions described herein. The modules can be stored in the memory 101 and executed by the processor 103. The memory 101 can be implemented within the processor 103 or external to the processor 103 in which case those can be communicatively coupled to the processor 103 via various means as is known in the art.

In some embodiments, the memory 101 stores executable instructions that when executed by the processor 103 cause the processor 103 to effectuate operations including: receiving, by a network exposure function (NEF), an application function (AF) session create request from an AF, wherein the AF session create request is associated with a group of AF sessions and one or more quality-of-service (QoS) parameters and partitioning, by the NEF, the AF session create request into one or more first requests, wherein the one or more first requests are associated with one or more user equipments (UEs). This can solve these issues in the prior art and other issues and/or reduce a signaling overhead between an AF and a network such as a 5G core network (5GC).

FIG. 2 illustrates a wireless communication method for a group of sessions by a function entity according to an embodiment of the present disclosure. FIG. 2 is an example of a communication method 200 for a group of sessions according to an embodiment of the present disclosure. The communication method 200 for a group of sessions is configured to implement some embodiments of the disclosure. Some embodiments of the disclosure may be implemented into the communication method 200 for a group of sessions using any suitably configured hardware and/or software. In some embodiments, the communication method 200 for a group of sessions includes: an operation 202, receiving, by a network exposure function (NEF), an application function (AF) session create request from an AF, wherein the AF session create request is associated with a group of AF sessions and one or more quality-of-service (QoS) parameters, and an operation 204, partitioning, by the NEF, the AF session create request into one or more first requests, wherein the one or more first requests are associated with one or more user equipments (UEs). This can solve these issues in the prior art and other issues and/or reduce a signaling overhead between an AF and a network such as a 5G core network (5GC).

In some embodiments, the one or more QoS parameters are associated with the group of AF sessions. In some embodiments, the method further includes converting, by the NEF, the one or more first requests into one or more second requests to one or more policy control function (PCF) entities. In some embodiments, the one or more second requests are one or more N5 requests. In some embodiments, the method further includes determining, by the NEF, the one or more PCF entities serving the one or more UEs. In some embodiments, the AF session create request includes a group of UE addresses, an AF identifier (ID), a flow description information, an external application ID, a QoS reference, the one or more QoS parameters, and/or one or more service requirements.

In some embodiments, the method further includes the NEF being requested by the AF to allocate QoS dedicated resources for the group of AF sessions and/or to perform QoS monitoring. In some embodiments, the method further includes reporting, by the NEF, one or more QoS flow level events to the AF corresponding to the group of AF sessions. In some embodiments, the method further includes the NEF being requested by the AF to revoke the group of AF sessions. In some embodiments, the method further includes the NEF being requested by the AF to update a list of UEs of the group of AF sessions, one or mor service requirements for the group of AF sessions, and/or a type of QoS monitoring operation.

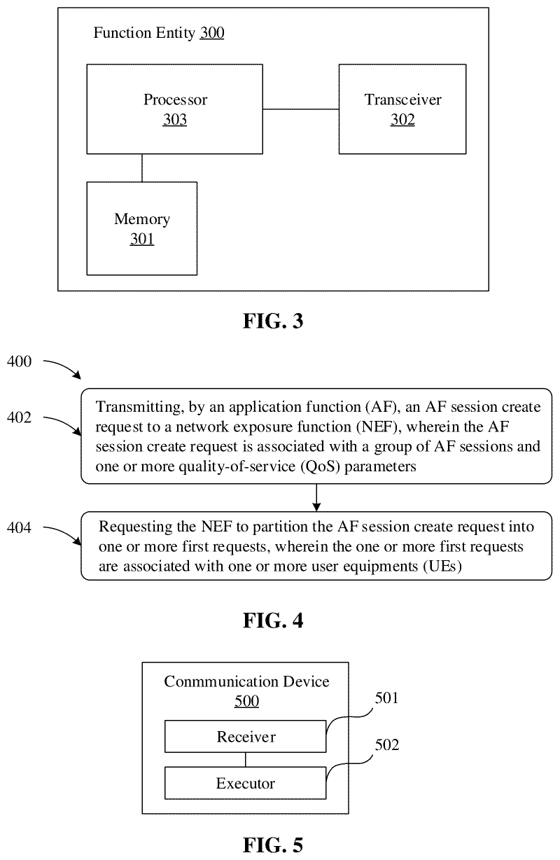

FIG. 3 illustrates an example of a function entity 300 according to an embodiment of the present disclosure. The function entity 300 is configured to implement some embodiments of the disclosure. Some embodiments of the disclosure may be implemented into the function entity 300 using any suitably configured hardware and/or software. The function entity 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the memory 301 stores executable instructions that when executed by the processor 303 cause the processor 303 to effectuate operations including: transmitting, by an application function (AF), an AF session create request to a network exposure function (NEF), wherein the AF session create request is associated with a group of AF sessions and one or more quality-of-service (QoS) parameters and requesting the NEF to partition the AF session create request into one or more first requests, wherein the one or more first requests are associated with one or more user equipments (UEs).

FIG. 4 illustrates a communication method for a group of sessions by a function entity according to an embodiment of the present disclosure. FIG. 4 is an example of a communication method 400 for a group of sessions according to an embodiment of the present disclosure. The communication method 400 for a group of sessions is configured to implement some embodiments of the disclosure. Some embodiments of the disclosure may be implemented into the communication method 400 for a group of sessions using any suitably configured hardware and/or software. In some embodiments, the communication method 400 for a group of sessions includes: an operation 402, transmitting, by an application function (AF), an AF session create request to a network exposure function (NEF), wherein the AF session create request is associated with a group of AF sessions and one or more quality-of-service (QoS) parameters, and an operation 404, requesting the NEF to partition the AF session create request into one or more first requests, wherein the one or more first requests are associated with one or more user equipments (UEs). This can solve these issues in the prior art and other issues and/or reduce a signaling overhead between an AF and a network such as a 5G core network (5GC).

In some embodiments, the one or more QoS parameters are associated with the group of AF sessions. In some embodiments, the method further includes requesting the NEF to convert the one or more first requests into one or more second requests to one or more policy control function (PCF) entities. In some embodiments, the one or more second requests are one or more N5 requests. In some embodiments, the method further includes requesting the NEF to determine the one or more PCF entities serving the one or more UEs. In some embodiments, the AF session create request includes a group of UE addresses, an AF identifier (ID), a flow description information, an external application ID, a QoS reference, the one or more QoS parameters, and/or one or more service requirements.

In some embodiments, the method further includes requesting the NEF to allocate QoS dedicated resources for the group of AF sessions and/or to perform QoS monitoring. In some embodiments, the method further includes requesting the NEF to report one or more QoS flow level events to the AF corresponding to the group of AF sessions. In some embodiments, the method further includes requesting the NEF to revoke the group of AF sessions. In some embodiments, the method further includes requesting the NEF to update a list of UEs of the group of AF sessions, one or mor service requirements for the group of AF sessions, and/or a type of QoS monitoring operation.

FIG. 5 illustrates a communication device according to an embodiment of the present disclosure. FIG. 5 illustrates that, in some embodiments, a communication device 500 includes a receiver 501 configured to receive an application function (AF) session create request from an AF, wherein the AF session create request is associated with a group of AF sessions and one or more quality-of-service (QoS) parameters and an executor 502 configured to partition the AF session create request into one or more first requests, wherein the one or more first requests are associated with one or more user equipments (UEs). This can solve these issues in the prior art and other issues and/or reduce a signaling overhead between an AF and a network such as a 5G core network (5GC).

In some embodiments, the one or more QoS parameters are associated with the group of AF sessions. In some embodiments, the executor 502 is configured to convert the one or more first requests into one or more second requests to one or more policy control function (PCF) entities. In some embodiments, the one or more second requests are one or more N5 requests. In some embodiments, the executor 502 is configured to determine the one or more PCF entities serving the one or more UEs. In some embodiments, the AF session create request includes a group of UE addresses, an AF identifier (ID), a flow description information, an external application ID, a QoS reference, the one or more QoS parameters, and/or one or more service requirements.

In some embodiments, the executor 502 is configured to allocate QoS dedicated resources for the group of AF sessions and/or to perform QoS monitoring. In some embodiments, the executor 502 is configured to report one or more QoS flow level events to the AF corresponding to the group of AF sessions. In some embodiments, the executor 502 is configured to revoke the group of AF sessions. In some embodiments, the executor 502 is configured to update a list of UEs of the group of AF sessions, one or mor service requirements for the group of AF sessions, and/or a type of QoS monitoring operation.

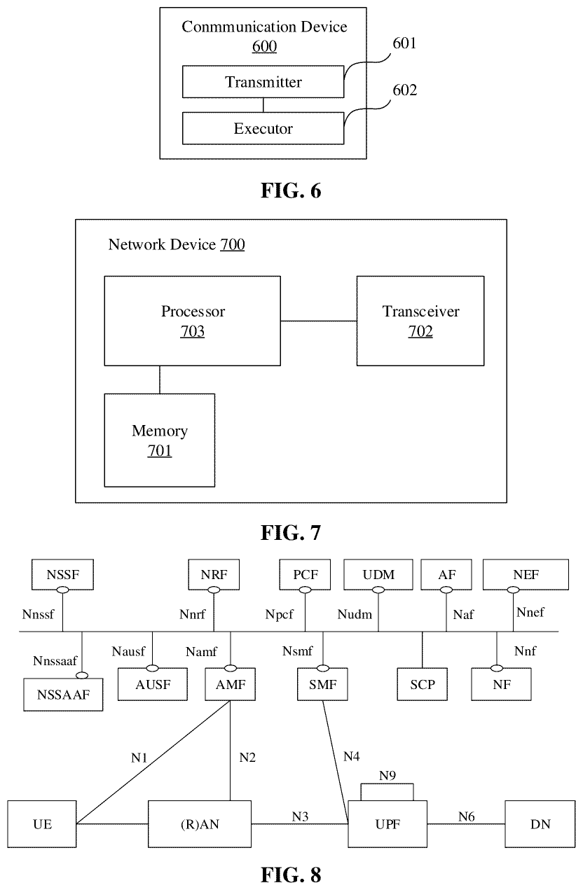

FIG. 6 illustrates a communication device according to an embodiment of the present disclosure. FIG. 6 illustrates that, in some embodiments, a communication device 600 includes a transmitter 601 configured to transmit an application function (AF) session create request to a network exposure function (NEF), wherein the AF session create request is associated with a group of AF sessions and one or more quality-of-service (QoS) parameters and an executor 602 configured to request the NEF to partition the AF session create request into one or more first requests, wherein the one or more first requests are associated with one or more user equipments (UEs). This can solve these issues in the prior art and other issues and/or reduce a signaling overhead between an AF and a network such as a 5G core network (5GC).

In some embodiments, the one or more QoS parameters are associated with the group of AF sessions. In some embodiments, the executor 602 is configured to request the NEF to convert the one or more first requests into one or more second requests to one or more policy control function (PCF) entities. In some embodiments, the one or more second requests are one or more N5 requests. In some embodiments, the executor 602 is configured to determine the one or more PCF entities serving the one or more UEs. In some embodiments, the AF session create request includes a group of UE addresses, an AF identifier (ID), a flow description information, an external application ID, a QoS reference, the one or more QoS parameters, and/or one or more service requirements.

In some embodiments, the executor 602 is configured to allocate QoS dedicated resources for the group of AF sessions and/or to perform QoS monitoring. In some embodiments, the executor 602 is configured to report one or more QoS flow level events to the AF corresponding to the group of AF sessions. In some embodiments, the executor 602 is configured to revoke the group of AF sessions. In some embodiments, the executor 602 is configured to update a list of UEs of the group of AF sessions, one or mor service requirements for the group of AF sessions, and/or a type of QoS monitoring operation.

FIG. 7 illustrates an example of a network device 700 according to an embodiment of the present disclosure. The network device 700 is configured to implement some embodiments of the disclosure. Some embodiments of the disclosure may be implemented into the network device 700 using any suitably configured hardware and/or software. The network device 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the memory 701 stores executable instructions that when executed by the processor 703 cause the processor 703 to effectuate operations including: receiving, by a network exposure function (NEF), an application function (AF) session create request from an AF, wherein the AF session create request is associated with a group of AF sessions and one or more quality-of-service (QoS) parameters and partitioning, by the NEF, the AF session create request into one or more first requests, wherein the one or more first requests are associated with one or more user equipments (UEs). In some embodiments, the memory 701 stores executable instructions that when executed by the processor 703 cause the processor 703 to effectuate operations including: transmitting, by an application function (AF), an AF session create request to a network exposure function (NEF), wherein the AF session create request is associated with a group of AF sessions and one or more quality-of-service (QoS) parameters and requesting the NEF to partition the AF session create request into one or more first requests, wherein the one or more first requests are associated with one or more user equipments (UEs). This can solve these issues in the prior art and other issues and/or reduce a signaling overhead between an AF and a network such as a 5G core network (5GC).

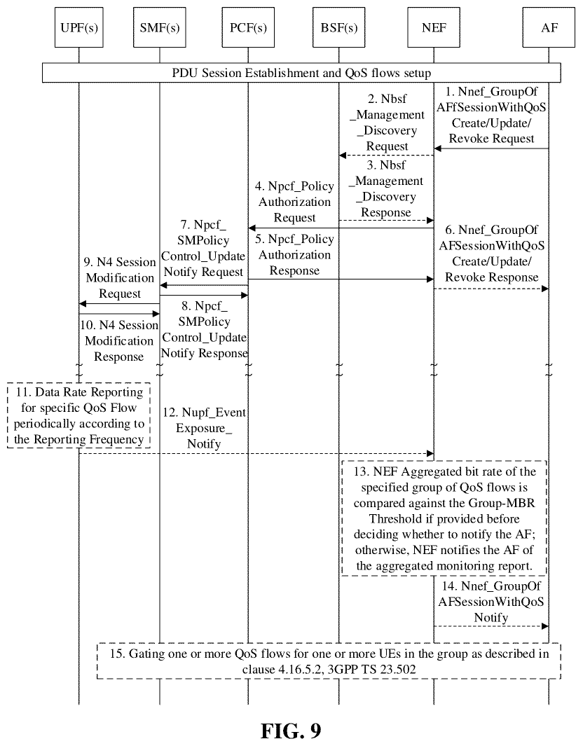

FIG. 8 illustrates a wireless communication architecture configured to implement some embodiments presented herein. FIG. 8 illustrates that in some embodiments, in the wireless communication architecture, network functions communicate with each other over a service-based interface in a core network (CN). A user equipment (UE) may communicate with the core network to establish control signaling and enable the UE to use services from the CN. Examples of control signaling functions are registration, connection and mobility management, authentication and authorization, session management, etc. After control signaling have been established, the UE can then utilize the user plane functionality to send and receive data to and from a data network (DN), e.g., the internet.

In some examples, the wireless communication architecture may include the following network functions (NF): authentication server function (AUSF), access and mobility management function (AMF), data network (DN), e.g., operator services, Internet access or 3rd party services, network exposure function (NEF), network repository function (NRF), network slice-specific and SNPN authentication and authorization function (NSSAAF), network slice selection function (NSSF), policy control function (PCF), session management function (SMF), unified data management (UDM), user plane function (UPF), application function (AF), user equipment (UE), (radio) access network ((R)AN), etc.

The following descriptions highlight some of the capabilities of the network functions (NFs) from FIG. 8 that are involved with control signaling.
Access and mobility function (AMF): The UE sends an NI message through the RAN node to the AMF to perform control plane signaling such as registration, connection management, mobility management, access authentication and authorization, etc.
Session management function (SMF): The SMF is responsible for session management involved with establishing PDU sessions to allow UEs to send data to Data Networks (DNS) such as the internet or to an application server and other session management related functions.
Policy and control function (PCF): The PCF provides the policy framework that governs network behavior, accesses subscription information to make policy decisions, etc.
Authentication server function (AUSF): The AUSF supports authentication of UEs for 3GPP and untrusted non-3GPP accesses.
Unified data management/repository (UDM/UDR): The UDM/UDR supports generation of 3GPP AKA Authentication Credentials, user identification handling, subscription management and storage, etc.
Network slice selection function (NSSF): The NSSF is involved with aspects of network slice management such as selection of network slice instances for UEs, management of NSSAIs, etc.
Network repository function (NRF): The NRF supports service discovery function in the 5G network.
Network exposure function (NEF): The NEF supports the exposure of capabilities and events in the core network to third parties, application functions (AFs), edge computing, etc.

The RAN node offers communication access from the UE to the core network for both control plane and user plane communications. A UE establishes a PDU session with the CN to send data traffic over the user plane through the (R)AN and UPF nodes of the 5G system (5GS). Uplink traffic is sent by the UE and downlink traffic is received by the UE using the established PDU session. Data traffic flows between the UE and the DN through the intermediary nodes: (R)AN and UPF.

### EXAMPLES

FIG. 9 is a flowchart illustrating of a group of AF sessions with QoS for resource allocation and/or QoS monitoring support configured to implement some embodiments presented herein. The flowchart illustrated in FIG. 9 includes at least one following step.
Step 1: An AF which controls an operation for a group of AF sessions invokes Nnef_GroupOfAFSessionWithQoS_Create/Update/Revoke Request with 5G core network via a support of NEF to allocate, update, or revoke, resource allocations and/or QoS monitoring for a group of QoS flows for a selected group of UEs. The group of QoS flows corresponding to a group of UEs' PDU sessions which may be selected to serve a group of data transfer for a specific application (e.g., FL operation).

In the step 1, if the AF is to set up the resource allocation for an initial group of UEs which may or may not include the request for specific QoS monitoring operation, it invokes the Nnef_GroupOfAFSessionWithQoS_Create request which includes the group of UE addresses, AF identifier, flow description information or external application identifier, QoS reference or individual QoS parameters, alternative service requirements (as described in clause 6.1.3.22 of TS 23.503, DNN, S-NSSAI) to the NEF. Optionally, a period of time or a traffic volume for the requested QoS can be included in the AF request. The AF may, instead of a QoS Reference, provide one or more of the following individual QoS parameters: Requested 5GS Delay (optional), Requested Priority (optional), Requested Guaranteed Bitrate, Requested Maximum Bitrate, Maximum Burst Size and Requested Packet Error Rate. QoS parameter(s) to be measured (Optional). The Group-MBR threshold for Group-MBR monitoring (Optional). Regardless of whether the AF request is formulated using a QoS Reference or individual QoS parameters, the AF may also provide one or more of the following parameters that describe the traffic characteristics flow direction, Burst Arrival Time at UE (uplink) or UPF (downlink). NOTE-1: If Group-MBR Threshold is provided, the QoS parameter(s) to be measured indicates the Guaranteed Bitrate shall be provided. NOTE-2: When the event report is for Group-MBR monitoring, the QoS Flow data rate reporting for the group of UEs provided to the AF by the NEF only when the Group-MBR threshold is exceeded.

In the step 1, if the AF is to update the UE list in the group and/or to update either the resource allocation and/or to update the type of QoS monitoring, the AF initiates the Nnef_GroupOfAFSessionWithQoS_Update request which includes the group of UE addresses, the AF Identifier, Transaction Reference ID, Flow description information, QoS Reference or individual QoS parameters, Alternative Service Requirements (as described in clause 6.1.3.22 of TS 23.503)] to NEF for updating the reserved resources. The Transaction Reference ID provided in the AF session with required QoS update request message is set to the Transaction Reference ID that is assigned by the NEF. The AF may, instead of a QoS Reference, provide one or more of the following individual QoS parameters: Requested 5GS Delay (optional), Requested Priority (optional), Requested Guaranteed Bitrate, Requested Maximum Bitrate, Maximum Burst Size and Requested Packet Error Rate. Regardless of whether the AF request is formulated using a QoS Reference or individual QoS parameters, the AF may also provide one or more of the following parameters that describe the traffic characteristics: flow direction, Burst Arrival Time at UE (uplink) or UPF (downlink). QoS parameter(s) to be measured (Optional). The Group-MBR threshold for Group-MBR monitoring if requested. The optional Alternative Service Requirements provided by the AF shall either contain QoS References or Requested Alternative QoS Parameter Set(s) in a prioritized order as specified in clause 6.1.3.22 of TS 23.503. NOTE-1: If Group-MBR Threshold is provided, the QoS parameter(s) to be measured indicates the Guaranteed Bitrate shall be provided. NOTE-2: When the event report is for Group-MBR monitoring, the QoS Flow data rate reporting for the group of UEs provided to the AF by the NEF only when the Group-MBR threshold is exceeded.

In the step 1, if the AF revokes the Group of AF sessions, it initiates the Nnef_GroupOfAFSessionWithQoS_Revoke request by including the Transaction Reference Id which was assigned by the NEF to the AF for the corresponding target group.
Steps 2 and 3: NEF authorizes the AF request. The NEF partitions the AF request which contains the list of UEs into individual UE's request to BSF or into a group of UEs' requests which are served by the same BSF. The NEF determines the UE's corresponding serving PCF address based on the local configuration or the NEF consumes Nbsf_Management Discovery service operation to find out the address of the UE's serving PCF.
Steps 4 and 5: Once the UE(s)′ serving PCF(s) are identified, the NEF converts the AF's request into individual N5 request to each UE's serving PCF. The UE's serving PCF authorizes the NEF request and responds to NEF with Npcf_Policy Authorization response according to the success or failure of the authorization.

In the steps 4 and 5, A. if the AF requests for Nnef_GroupofAFSession_Create to set up the group of AF sessions with resource allocation for a group of UEs, the NEF requests the individual UE's serving PCF to derive the required QoS parameters of the PCC rule based on the information provided by the NEF and determines whether this QoS is allowed (according to the PCF configuration) and notifies the result to the NEF. Step 4 as described in clause 4.15.6.6 of TS 23.502 is referred to further describe how the UE's serving PCF derives the PCC rules towards the UE's serving SMF when it receives the QoS reference or individual QoS parameters from the AF via NEF.

In the steps 4 and 5, A. if the Nnef_GroupOfAFSession_Create includes also the QoS parameter to be measured and the Group-MBR Threshold, NEF requests the PCF to initiate the QoS Monitoring event for Data Rate monitoring as specified in clauses 5.2.26 of TS 23.502 for a specific QoS flow, the NEF invokes PCF with the Npcf_PolicyAuthorization_Create request and includes the UE IP address, DNN and S-NSSAI, Application Identifier, Flow description information as described in clause 6.1.3.6 of TS 23.503 or External Application Identifier, QoS Reference or individual QoS parameters as described in clause 6.1.3.22 of TS 23.503 to be measured, flow direction, the Reporting frequency, Target of reporting (i.e. NEF), DNN, S-NSSAI, Transaction Reference Id, optional Alternative Service Requirements (containing one or more QoS Reference parameters or Requested Alternative QoS Parameter Sets in a prioritized order). NOTE-1: If Group-MBR Threshold is provided, the QoS parameter(s) to be measured indicates the Guaranteed Bitrate shall be provided. NOTE-2: When the event report is for Group-MBR monitoring, the QoS Flow data rate reporting for the group of UEs provided to the AF by the NEF only when the Group-MBR threshold is exceeded.

In the steps 4 and 5, B. if the AF requests for Nnef_GroupofAFSession_Revoke to delete the entire Group AF session, the NEF invokes the Npcf_Policy Authorization_Delete service to the group of UEs' respective serving PCFs, NEF notifies each UE's serving PCF to remove the N4 policy by referring to the AF Transaction Id. The UE's serving PCF responds to the NEF according to the authorization status of the NEF request.

In the steps 4 and 5, C. if the AF requests for Nnef_GroupOfAFSessionWithQoS_Update in order to update the list of UEs in the group for the resource allocation, the NEF refers to the local context of the corresponding to the list of UEs in the group and determines for which the new UE is to be added to the group, for which of the existing UE is to be removed from the group and/or for which of the existing UE is to be updated by invoking one or more of the following Npcf_Policy Authorization procedures:
i. If the group AF session update request involves a new UE is to be added to the group with resource allocation, the NEF initiates the Npcf_PolicyAuthorization_Create as described in A. above towards the PCF for the corresponding UE can be followed.
ii. If the group AF session update request involves an existing UE is to be removed to the group, the NEF initiates the Npcf_PolicyAuthorization_Delete as described above B. towards the PCF for the corresponding UE can be followed.
iii. If the group AF session update request involves either the update the QoS resources or QoS monitoring or both for the existing UE in the group, the NEF initiates the Npcf_PolicyAuthorization_Update to the UE's serving PCF. The PCF processes the Npcf_PolicyAuthorization_Update request similar to the Group AF session create request as described in A. above.
Step 6: NEF aggregates the authorization responses from the PCFs and sends the AF with the Nnef_AFGroupOfSessionsWithQoS Create/Update/Revoke response corresponding to the earlier Group AF session request. The consolidated response for NEF provides specific success or failure response corresponding to each UE.
Steps 7 and 8: If NEF requested Npcf_PolicyAuthorization_Create/Update is authorized by the PCF, and the PCF determines that the SMF needs updated policy information, the PCF issues a Npcf_SMPolicyControl_UpdateNotify request with updated policy information about the PDU Session as described in the PCF initiated SM Policy Association Modification procedure in clause 4.16.5.2 of TS 23.502. If NEF requested Npcf_Policy Authorization_Delete is authorized by the PCF, the PCF triggers Npcf_SMPolicyControl_Delete service operation towards the SMF.
Steps 9 and 10: If the SMF receives the create or the update of the policy information for the PDU session provided by the PCF as described in step 7 above, SMF initiates N4 Session Modification procedure to update the N4 session context of an existing PDU Session at the UPF as described in clause 4.4.1.3 of TS 23.502. The updated N4 Session may require the SMF to initiate the requested action to trigger the QoS Monitoring event for Data Rate Monitoring as specified in clauses 5.2.26 of TS 23.502 for the target QoS flow. If the SMF receives the deletion of the policy information for the PDU session, the SMF notifies the PSA UPF to terminate the QoS Monitoring event for Data Rate Monitoring for the target Qos flow. SMF acknowledges the PCF request with a Npcf_SMPolicyControl_UpdateNotify response.
Step 11: When received the PCF request, the SMF is then to provision the PSA UPF to remove the reporting, or to initiate the reporting of Data Rate Monitoring via Nupf_EventExposure_Notify to the NEF periodically in accordance with the Reporting frequency.
Step 12: If the QoS Monitoring event for Data Rate Monitoring is indicated by the SMF, the UPF reports the bit rate for the target QoS flow periodically to the NEF; otherwise, if the QoS Monitoring event for Data Rate Monitoring is revoked by the SMF, the UPF terminate the UPF reporting.
Step 13: If receiving the Data Rate Monitoring report of the QoS Monitoring event for specific QoS flow from UPFs, and the Group-MBR threshold was provided by the prior Nnef_GroupOfAFSessionWithQoS request, the NEF sums up the bit rates of all the active QoS flows through the duration of the Reporting Frequency. If the given Application AI/ML traffic is asymmetric, the bit rate aggregation is done per uplink and downlink separately; otherwise, the bit rate aggregation is done per either uplink or downlink. NEF compares the aggregated bit rate of the uplink or downlink against the Group-MBR threshold for the uplink or downlink, accordingly. If the Group-MBR threshold was not provided, the NEF collects all the UPF QoS monitoring reports through the duration of the Reporting Frequency.
Step 14: Only if the aggregate bit rate exceeds the Group-MBR threshold specified by the AF, the NEF will notify the Application AI/ML AF via Nnef_AFGroupOfSessionsWithQoS_Notify for the collected UPF QoS monitoring reports together with the AF Transaction Reference ID; otherwise, the NEF always notify the AF with the collected UPF QoS monitoring reports together with the AF Transaction Reference ID.
Step 15: AF may apply traffic mediation action in responding to the Group-MBR monitoring report (e.g. requesting 5G Core to apply traffic gating on specific QoS flow such as asking 5GC to block some of the flows) or may decide not to take any action other than using it for its own statistics or charging. The decision is local implementation decision is not within the scope of this procedure.

The UPF QoS Monitoring event for Data Rate Monitoring continues until AF terminates the Group-MBR monitoring. The UPF continues to perform the QoS Monitoring event for Data Rate Monitoring for the given QoS flow to the NEF periodically corresponding to the Reporting Frequency as described in steps 11-12 above. If AF wants to terminate the Group-MBR monitoring, AF sends the Nnef_AFGroupOfSessionsWithQoS_Revoke request to NEF which includes the AF Transaction Reference ID.

TABLE 2
illustrates new NEF service and operations.

| | Service | Operation | Example |
|---|---|---|---|
| Service Name | Operations | Semantics | Consumer(s) |
| Nnef_GroupOfAFSessionWithQoS | Create | Request/Response | AF |
| | Notify | Request/Response | AF |
| | Update | Request/Response | AF |
| | Revoke | Request/Response | AF |

### Nnef_GroupOfAFSessionWithQoS Service

### General

In addition to supporting the QoS resource allocation for a group of UEs, this service is also used to support subscription and notification of QoS Monitoring event for Data Rate Monitoring for a group of QoS flows, as described in clause 5.2.26 of TS 23.502.

### Nnef_GroupOfAFSessionWithQoS_Create Service Operation

Service operation name: Nnef_GroupOfAFSessionWithQoS Create
Description: The consumer requests the network to allocate QoS dedicated resources for a specific group of AF sessions and potentially to perform QoS monitoring (e.g., delay, jitter, bit rate or Group-MBR).
Inputs, Required: AF Identifier, a list of UE addresses (i.e. IP addresses), Flow description information as described in clause 6.1.3.6 of TS 23.503 or External Application Identifier, QoS Reference or individual QoS parameters as described in clause 6.1.3.22 of TS 23.503.
Inputs, Optional: Time Period, Traffic Volume, Alternative Service Requirements (containing one or more QoS Reference parameters or Requested Alternative QoS Parameter Sets in a prioritized order), QoS parameter(s) to be measured, Group-MBR Threshold, Reporting frequency, Target of reporting and optional an indication of local event notification as described in clause 6.1.3.21 of TS 23.503, DNN if available, S-NSSAI if available, flow direction.
NOTE-1: If Group-MBR Threshold is provided, the QoS parameter(s) to be measured indicates the Guaranteed Bitrate shall be provided.
NOTE-2: When the event report is for Group-MBR monitoring, the QoS Flow data rate reporting for the group of UEs provided to the AF by the NEF only when the Group-MBR threshold is exceeded.
Outputs, Required: Transaction Reference ID, result for the success or failure of the request corresponding to individual UE(s) in the list.
Output (optional): None.

### Nnef_GroupOfAFSessionWithQoS_Notify Service Operation

Service operation name: Nnef_GroupOfAFSessionWithQoS_Notify
Description: NEF reports the QoS Flow level event(s) to the consumer corresponding to the group of AF sessions.
Inputs, Required: Transaction Reference ID, Delivery reports of the events as defined in clause 6.1.3.18 of TS 23.503.
NOTE: When the event report is for Group-MBR monitoring, the QoS Flow data rate reporting for the group of UEs provided to the AF by the NEF only when the Group-MBR threshold is exceeded.
Inputs, Optional. When the delivery report is for Group-MBR Monitoring, includes Group-MBR Monitoring report
Outputs, Required: None.
Output (optional): None.
Nnef_GroupOfAFSessionWithQoS_Revoke service operation
Service operation name: Nnef_GroupOfAFSessionWithQoS_Revoke
Description: The consumer requests the network to revoke the group of AF sessions.
Inputs, Required: Transaction Reference ID.
Inputs, Optional: None.
Outputs, Required: Transaction Reference ID, result for the success or failure of the request corresponding to individual UE.
Output (optional): None.

### Nnef_GroupAFSessionWithQoS_Update Service Operation

Service operation name: Nnef_GroupOfAFSessionWithQoS_Update
Description: The consumer requests the network to update list of UEs (identified by IP addresses) of the group of AF sessions, the Service Requirement(s) and/or additional Alternative Service Requirement(s) for a group of AF sessions and/or the type of QoS monitoring operation.
Inputs, Required: Transaction Reference ID. AF Identifier, a list of UE addresses (i.e. IP addresses), Flow description information as described in clause 6.1.3.6 of TS 23.503 or External Application Identifier.
Inputs, Optional: QoS Reference or individual QoS parameters as described in clause 6.1.3.22 of TS 23.503, time period, traffic volume, Alternative Service Requirements (containing one or more QoS Reference parameters or Requested Alternative QoS Parameter Sets in a prioritized order), QoS parameter(s) to be measured, Group-MBR Threshold, Reporting frequency, Target of reporting and optional an indication of local event notification as described in clause 6.1.3.21 of TS 23.503, flow direction.
NOTE-1: If Group-MBR Threshold is provided, the QoS parameter(s) to be measured indicates the Guaranteed Bitrate shall be provided.
NOTE-2: When the event report is for Group-MBR monitoring, the QoS Flow data rate reporting for the group of UEs provided to the AF by the NEF only when the Group-MBR threshold is exceeded.
Outputs, Required: Transaction Reference ID, result for the success or failure of the operation execution result.
Output (optional): None.

In summary, a new NEF service is introduced by some embodiments of this disclosure to support the network resource allocation and various QoS monitoring operation for a group of AF sessions which have been set up for a group of UEs selected by the AF. Each AF session within the group, if authorized by the PCF, is allocated with the same set of QoS resources as requested by the AF. If the QoS monitoring is also requested for the group, the group of QoS flows for the corresponding UEs within the group which participate in the same application is to be monitored as requested by the AF. One or more QoS parameters to be measured are specified by the AF to imply the type of QoS monitoring measurement (e.g., delay, jitter and/or data rate etc.). By adopting the solution proposed by some embodiments of this disclosure, the signaling overhead between the AF and the 5GC can be reduced.

Commercial interests for some embodiments are as follows. 1. Solve issues in the prior art and other issues. 2. Reduce a signaling overhead between an AF and a network such as a 5G core network (5GC). Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, a network device, and/or a communication system. Compatible products follow at least one proposed solution, method, system, and apparatus of some embodiments of the present disclosure. The proposed solution, method, system, and apparatus are widely used in a UE, a base station, a network device, and/or a communication system. With the implementation of the at least one proposed solution, method, system, and apparatus of some embodiments of the present disclosure, at least one modification/improvement to methods and apparatus for a group of sessions are considered for standardizing.

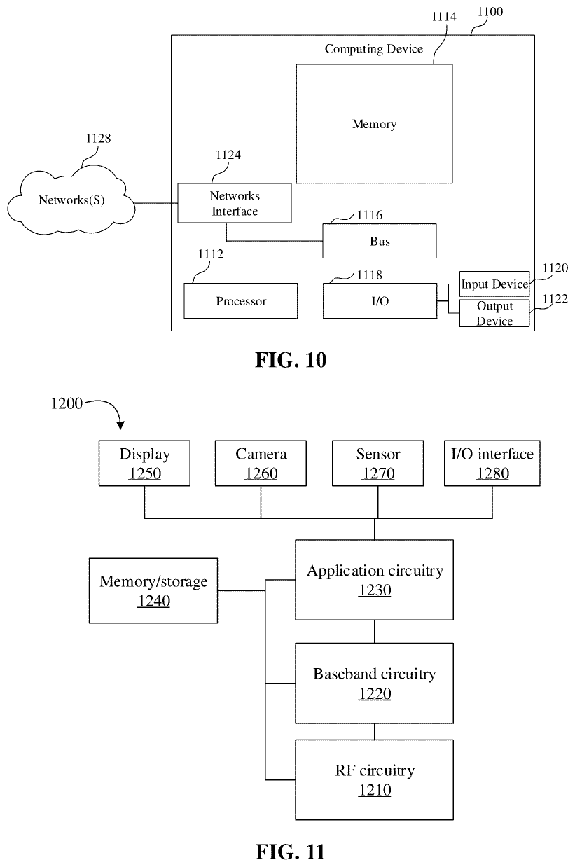

FIG. 10 is an example of a computing device 1100 according to an embodiment of the present disclosure. Any suitable computing device can be used for performing the operations described herein. For example, FIG. 10 illustrates an example of the computing device 1100 that can implement apparatus and/or methods illustrated in FIG. 2 to FIG. 9 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments illustrated in FIG. 2 to FIG. 9. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 11 is a block diagram of an example of a communication system 1200 according to an embodiment of the present disclosure. Embodiments described herein may be implemented into the communication system 1200 using any suitably configured hardware and/or software. FIG. 11 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to FIG. 2 to FIG. 9. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and/or methods illustrated in FIG. 2 to FIG. 9 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an Ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for a group of sessions, comprising:
receiving, by a network exposure function (NEF), an application function (AF) session create request from an AF, wherein the AF session create request is associated with a group of AF sessions and one or more quality-of-service (QoS) parameters; and
partitioning, by the NEF, the AF session create request into one or more first requests, wherein the one or more first requests are associated with one or more user equipments (UEs).

2. (canceled)

3. The method of claim 1, further comprising converting, by the NEF, the one or more first requests into one or more second requests to one or more policy control function (PCF) entities.

4. (canceled)

5. The method of claim 3, further comprising determining, by the NEF, the one or more PCF entities serving the one or more UEs.

6. The method of claim 1, wherein the AF session create request comprises a group of UE addresses, an AF identifier (ID), a flow description information, an external application ID, a QoS reference, the one or more QoS parameters, and/or one or more service requirements.

7-13. (canceled)

14. A network exposure function (NEF), comprising:
a memory;
a transceiver; and
a processor coupled to the memory and the transceiver;
wherein the processor is configured to cause the NEF to perform operations of:
receiving an application function (AF) session create request from an AF, wherein the AF session create request is associated with a group of AF sessions and one or more quality-of-service (QoS) parameters; and
partitioning the AF session create request into one or more first requests, wherein the one or more first requests are associated with one or more user equipments (UEs).

15-16. (canceled)

17. The NEF of claim 14, wherein the one or more QoS parameters are associated with the group of AF sessions.

18. The NEF of claim 14, wherein the processor is further configured to cause the NEF to: convert the one or more first requests into one or more second requests to one or more policy control function (PCF) entities.

19. The NEF of claim 18, wherein the processor is further configured to cause the NEF to: determine the one or more PCF entities serving the one or more UEs.

20. The NEF of claim 14, wherein the AF session create request comprises a group of UE addresses, an AF identifier (ID), a flow description information, an external application ID, a QoS reference, the one or more QoS parameters, and/or one or more service requirements.

21. The NEF of claim 14, wherein the processor is further configured to cause the NEF being requested by the AF to allocate QoS dedicated resources for the group of AF sessions and/or to perform QoS monitoring.

22. The NEF of claim 14, wherein the processor is further configured to cause the NEF to: report one or more QoS flow level events to the AF corresponding to the group of AF sessions.

23. The NEF of claim 14, wherein the processor is further configured to cause the NEF being requested by the AF to revoke the group of AF sessions.

24. The NEF of claim 14, wherein the processor is further configured to cause the NEF being requested by the AF to update a list of UEs of the group of AF sessions, one or more service requirements for the group of AF sessions, and/or a type of QoS monitoring operation.

25. An application function (AF), comprising:
a memory;
a transceiver; and
a processor coupled to the memory and the transceiver;
wherein the processor is configured to cause the AF to perform operations of:
transmitting an AF session create request to a network exposure function (NEF), wherein the AF session create request is associated with a group of AF sessions and one or more quality-of-service (QoS) parameters; and
requesting the NEF to partition the AF session create request into one or more first requests, wherein the one or more first requests are associated with one or more user equipments (UEs).

26. The AF of claim 25, wherein the one or more QoS parameters are associated with the group of AF sessions.

27. The AF of claim 25, wherein the AF session create request comprises a group of UE addresses, an AF identifier (ID), a flow description information, an external application ID, a QoS reference, the one or more QoS parameters, and/or one or more service requirements.

28. The AF of claim 25, wherein the processor is further configured to cause the AF to: request the NEF to allocate QoS dedicated resources for the group of AF sessions and/or to perform QoS monitoring.

29. The AF of claim 25, wherein the processor is further configured to cause the AF to: receive one or more QoS flow level events.

30. The AF of claim 25, wherein the processor is further configured to cause the AF to: request the NEF to revoke the group of AF sessions.

31. The AF of claim 25, wherein the processor is further configured to cause the AF to: request the NEF to update a list of UEs of the group of AF sessions, one or more service requirements for the group of AF sessions, and/or a type of QoS monitoring operation.
